(19) United States
(12) Patent Application Publication
(10) Pub. No.: US 2004/0010105 A1
(43) Pub. Date: Jan. 15, 2004

(54) Slurry polymerization with unsupported late transition metal catalyst

(76) Inventors: Linda N. Winslow, Cincinnati, OH (US); Michael W. Lynch, West Chester, OH (US)

Correspondence Address: LYONDELL CHEMICAL COMPANY, 3801 WEST CHESTER PIKE, NEWTOWN SQUARE, PA, 19073, US

(21) Appl. No.: 10/194,030

(22) Filed: Jul. 11, 2002

(51) Int. Cl. C08F 4/44

(52) U.S. Cl. 526/161; 526/172; 526/169.1

(57) ABSTRACT

A slurry ethylene polymerization process is disclosed. The process uses an unsupported late transition metal catalyst that comprises an acenaphthene N,N′-bis(arylimine) ligand. The process is conducted in the presence of a non-aromatic hydrocarbon diluent. The process produces polyethylene having high molecular weight in powder form and it gives high catalyst activity at relatively high temperatures.

### FIELD OF THE INVENTION

The invention relates to slurry polymerization of ethylene using an unsupported late transition metal catalyst. More particularly, the invention relates to a slurry process that has a high catalyst activity at a relatively high polymerization temperature.

### BACKGROUND OF THE INVENTION

Late transition metal (Group 8-10) catalysts are known. These catalysts often contain neutral bidentate ligands such as diimine. Other ligands such as halides are used to satisfy the total valence of the late transition metal. Nickel and palladium are commonly used. The catalysts can be used with activators that are used for single-site or Ziegler catalysts, including aluminoxane and alkyl aluminum.

Unlike Ziegler or single-site catalysts, the late transition catalysts have low activity in olefin polymerization. They often produce olefin dimers or oligomers, rather than polymers. With the late transition metal catalysts, high molecular weight polyolefins can be produced at very low temperature (0° C.-25° C.). See, e.g., L. Johnson et al., J. Am. Chem. Soc., 117, 6414 (1995). However, the low temperature polymerization is commercially impractical.

U.S. Pat. No. 6,194,341 teaches mixing a late transition catalyst with a Ziegler or single-site catalyst. The mixed catalyst produces polyethylene having a bi-modal molecular weight distribution in which the late transition metal catalyst contributes to a low molecular weight portion and the Ziegler or Single-site catalyst contributes to a high molecular weight portion.

U.S. Pat. No. 6,127,497 teaches polymerizing ethylene with late transition catalysts that contain acenaphthene bis-N,N′-(2,6-diisopropylphenyl)imine ligand. The polymerization is conducted in toluene solution at high temperatures (120° C.-165° C.) under high pressure (1350-1750 bars). Under these conditions, the catalyst shows very low activity.

New methods for making ethylene polymers with late transition catalysts are needed. Ideally, the method would give high catalyst activity under commercially practicable conditions. Ideally, the polymer would be produced in a slurry process.

### SUMMARY OF THE INVENTION

The invention is a slurry process for producing polyethylene or copolymers of ethylene and a C₃-C₁₀ α-olefin. The process is conducted in the presence of a non-aromatic hydrocarbon diluent, an activator, and an unsupported late transition metal catalyst. The late transition metal catalyst comprises an acenaphthene N,N′-bis(arylimine) ligand.

We have surprisingly found that the process produces high molecular weight polymers and gives high catalyst activity even at high polymerization temperatures.

### DETAILED DESCRIPTION OF THE INVENTION

The invention is a slurry process. The process is conducted in the presence of a non-aromatic hydrocarbon diluent, an activator, and an unsupported late transition metal catalyst.

A Group 8-10 late transition metal catalyst is used. Preferably, the late transition metal is selected from the group consisting of nickel, palladium, iron, and cobalt. More preferably, the late transition metal is nickel.

The catalyst comprises that comprises an acenaphthene N,N′-bis(arylimine) ligand. The ligand preferably has the general structure:

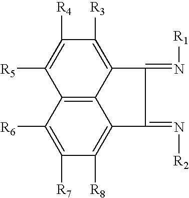

R₁ and R₂ are the same or different, and are selected from hydrogen, linear or branched C₁₋₁₀ alkyl, C₃₋₂₀ cycloalkyl, C₆₋₂₀ aryl, or C₇₋₂₀ aralkyl groups, each of the groups being optionally substituted with halogen, cyano, C₁₋₄alkoxy, or C₁₋₄ alkyl. R₃, R₄, R₅, R₆, R₇ and R₈ are the same or different, and are selected from hydrogen, C₁₋₁₀ alkyl, C₆₋₂₀ aryl, C₇₋₂₀ aralkyl, C₁₋₁₀ alkoxy, or C₁₋₁₀ dialkylamino groups, each of the groups being optionally substituted with halogen, cyano, C₁₋₄ alkoxy, or C₁₋₄ alkyl. Any two adjacent R₃ through R₈ optionally form a ring structure or a part of a ring structure. The ring structure optionally containing one or more heteroatoms selected from B, N, O, S, or P.

The late transition metal catalyst comprises other ligands. The total number of ligands satisfies the valence of the late transition metal. Examples include halides, substituted and unsubstituted cyclopentadienyls, indenyls, fluorenyls, alkyls, aryls, aralkyls, dialkylaminos, siloxys, alkoxys, thioethers, pyrrolyls, indolyls, carbazoyls, quinolinyls, pyridinyls, azaborolinyls, boraaryls, and the like, and mixtures thereof. Halides, siloxys, alkoxys, and thioalkoxys are preferred.

An example of a suitable late transition catalyst is acenaphthene bis-N,N′-(2,6,-diiopropylphenyl) imine nickel dibromide:

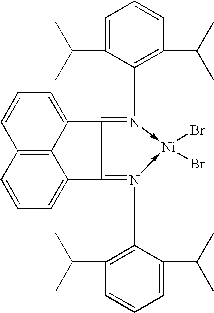

This catalyst is known and has been used for solution polymerization. See, e.g., L. Johnson et al., J. Am. Chem. Soc., 117, 6414 (1995). We have found that this catalyst gives very low activity in solution polymerization at high temperatures (e.g., 40° C., see Comparative Example 3).

The slurry process of the invention is conducted in a non-aromatic hydrocarbon diluent. We have found that using an aromatic hydrocarbon produces a polymer of low molecular weight that cannot be isolated in powder form (see Comparative Example 3). Preferably, the catalyst is insoluble in the reaction mixture.

Suitable non-aromatic hydrocarbons include propane, isobutane, hexane, heptane, cyclohexane, and the like, and mixtures thereof. The hydrocarbon diluent does not dissolve the late transition metal catalyst. Thus, the catalyst forms a slurry in the diluent without the need of supporting the catalyst.

Light hydrocarbons such as propane, butane, and isobutane are preferred. Using light hydrocarbons allows easy isolation of the polymer. After the polymerization, the hydrocarbons can be “flashed off” and the polymer can be quickly recovered in powder form.

The polymerization is preferably conducted at a temperature within the range of about 0° C. to about 115° C. More preferably, the temperature is within the range of about 20° C. to about 80° C. Most preferably, the temperature is within the range of about 20° C. to about 60° C. If the polymerization temperature is too high, the catalyst activity is reduced and the polymer produced has low molecular weight. If the polymerization temperature is too low, the process is costly. Removing the polymerization heat becomes difficult when the polymerization temperature is below or close to the environmental temperature. Furthermore, recovering the polymer becomes most costly if the polymerization temperature is below the boiling point of the hydrocarbon diluent.

The catalyst is used with an activator. Suitable activators include anionic compounds of boron and aluminum, trialkylborane and triarylborane compounds, and the like. Examples are lithium tetrakis(pentafluorophenyl) borate, triphenylcarbenium tetrakis(pentafluorophenyl)- borate, tris(pentafluorophenyl) borane, and methyl alumoxane (MAO), the like, and mixtures thereof. Activators are generally used in an amount within the range of about 0.01 to about 100,000, preferably from about 0.1 to about 10,000, and most preferably from about 0.5 to about 1,000, moles per mole of the late transition metal catalyst.

A scavenger is optionally used in the polymerization. Scavengers reduce the effect of a trace amount of moisture and oxygen existing in the reactor on the polymerization and increase the activity and lifetime of the catalysts. Suitable scavengers include alkyl aluminum compounds. Scavengers are added into the reactor prior to the addition of the catalyst.

Suitable α-olefins include propylene, 1-butene, 1-hexene, and 1-octene, and the like, and mixture thereof. Using α-olefins reduces the density of polyethylene. The more α-olefin is incorporated, the lower the density.

The following examples merely illustrate the invention. Those skilled in the art will recognize many variations that are within the spirit of the invention and scope of the claims.

### EXAMPLE 1

Br <Br Slurry Polymerization of Ethylene with Acenaphthene Bis-N,N′-(2,6-Diisopropylphenyl)lmine Nickel Dibromide in Isobutane

Catalyst Preparation

Acenaphthene bis-N,N′-(2,6-diisopropylphenyl)imine Nickel dibromide is prepared according to the methods described in Recl. Trav. Chim. Pays-Bas 1994, 113, 88-98 and Z. Naturforsch 1981, 366, 823-832.

Slurry Polymerization

The catalyst prepared above (1 mmole) and methyl aluminoxane (MMAO, product of Akzo-Nobel, 0.5 mL, 6.7% in heptane) are dispersed in isobutane (about 500 mL) in a 1L stainless-steel autoclave. The reactor contents are heated to 40° C. Ethylene is added to the reactor to 300 psig total pressure. The reaction is carried out at 40° C. for 30 minutes. Ethylene is continuously fed to maintain a constant reactor pressure. The reactor is vented and the polymer (35 g) is collected as a powder. The polymer has Mw: 1,470,000 and Tm: 116.9° C. The catalyst activity is 4.2 kg PE/g Ni.hr.psi.

### EXAMPLE 2

The procedure of Example 1 is repeated but the polymerization is carried out at 60° C. and 400 psig. The polymer is a powder and it has Mw: 606,000 and Tₘ: 75.5° C. The catalyst activity is 2.0 kg PE/g Ni.hr.psi.

### COMPARATIVE EXAMPLE 3

### Polymerization of Ethylene with Acenaphthene Bis-N,N′-(2,6-Diisopropylphenyl)lmine Nickel Dibromide In Toluene

The procedure of Example 1 is repeated but toluene, rather than isobutane, is used. Ethylene pressure is maintained at 15 psig. The polymer is soluble in the reaction medium and is isolated by precipitation in methanol. It has Mw: 215,000. The catalyst activity is 1.6 kg PE/g Ni.hr.psi.

We claim:

1. A slurry polymerization process comprising polymerizing ethylene and optionally one or more C₃-C₁₀ α-olefins in the presence of a non-aromatic hydrocarbon diluent, an activator, and an unsupported late transition metal catalyst that comprises an acenaphthene N,N′-bis(arylimine) ligand.

2. The process of claim 1 wherein the polymerization is conducted at a temperature within the range of about 0° C. to about 115° C.

3. The process of claim 1 wherein the polymerization is conducted at a temperature within the range of about 20° C. to about 80° C.

4. The process of claim 1 wherein the polymerization is conducted at a temperature within the range of about 20° C. to about 60° C.

5. The process of claim 1 wherein the non-aromatic diluent is selected from the group consisting of propane, isobutane, hexane, heptane, and cyclohexane.

6. The process of claim 1 wherein the non-aromatic diluent is isobutane.

7. The process of claim 1 wherein the C₃-C₁₀ α-olefin is selected from the group consisting of propylene, 1-butene, 1-pentene, 1-hexene, 1-octene, and mixtures thereof.

8. The process of claim 1 wherein the activator is selected from the group consisting of anionic compounds of boron or aluminum, trialkylboron compounds, and triarylboron compounds.

9. The process of claim 1 wherein the activator is an alumoxane.

10. The process of claim 1 wherein the late transition catalyst has the general structure: 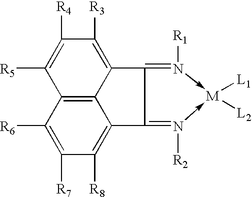
wherein M is a Group 8-10 late transition metal, R₁ and R₂ are the same or different, and are selected from the group consisting of hydrogen, linear and branched C₁-C₁₀ alkyl, C₃-C₂₀ cycloalkyl, C₆-C₂₀ aryl, and C₇-C₂₀ aralkyl groups; R₃, R₄, R₅, R₆, R₇ and R₈ are the same or different, and are selected from the group consisting of hydrogen, C₁-C₁₀ alkyl, C₆-C₂₀ aryl, C₇-C₂₀ aralkyl, C₁-C₁₀ alkoxy, and C₁-C₁₀ dialkylamino groups; and L₁ and L₂ are the same or different, and are anionic ligands.

11. The process of claim 10 wherein the late transition metal is selected from the group consisting of nickel, palladium, iron, and cobalt.

12. The process of claim 10 wherein the late transition metal is nickel.

13. The process of claim 10 wherein L₁ and L₂ are independently selected from the group consisting of halides, substituted and unsubstituted cyclopentadienyls, indenyls, fluorenyls, alkyls, aryls, aralkyls, dialkylaminos, siloxys, alkoxys, thioalkoxys, pyrrolyls, indolyls, carbazoyls, quinolinyls, pyridinyls, azaborolinyls, boraaryls, and mixtures thereof.

14. The process of claim 10 wherein L₁ and L₂ are independently selected from the group consisting of halides, siloxys, alkoxys, thioalkoxys, and mixtures thereof.

15. The process of claim 10 wherein both L₁ and L₂ are bromide.

16. The process of claim 10 wherein the late transition metal catalyst is acenaphthene bis-N,N′-(2,6-diisopropylphenyl)imine nickel dibromide.
